(19) United States
(12) Patent Application Publication
(10) Pub. No.: US 2007/0054831 A1
(43) Pub. Date: Mar. 8, 2007

(54) Use of nonionic surfactant in a laundry treatment composition

(76) Inventors: Christopher Boardman, Wirral (GB); Gillian Shella McHattie, Wirral (GB); Samantha Small, Wirral (GB); Neil Fletcher Taylor, Wirral (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/557,943

(22) PCT Filed: Apr. 22, 2004
(86) PCT No.: PCT/EP04/04260

§ 371 Date: Nov. 21, 2005

(30) Foreign Application Priority Data
May 21, 2003 (GB) 0311699.3
May 21, 2003 (GB) 0311700.9

(51) Int. Cl. C11D 17/08

(52) U.S. Cl. 510/421

(57) ABSTRACT

The use of a nonionic surfactant in a laundry treatment composition reduces the drying time of laundered fabrics. Preferably the nonionic surfactant is an addition product of ethylene and/or propylene oxide with fatty alcohols, fatty acids or fatty amines.

### FIELD OF THE INVENTION

The present invention relates to the use of a nonionic surfactant in a laundry treatment composition. More specifically, the present invention relates to the use of a nonionic surfactant in a laundry treatment composition to reduce the drying time of laundered fabrics.

### BACKGROUND OF THE INVENTION

In the treatment of laundry, there is typically a long drying process required after a batch of fabrics has been washed. Traditionally, this has involved hanging the laundered fabrics on a line in an outdoor environment for a period of several hours. Of course, this has always been subject to the risk of adverse weather conditions, such as rain, which could cause a substantial prolongation of the drying time.

It has also been common to provide an indoor drying line which is for instance, hung over a bath. Again, full drying typically takes several hours or longer.

Since the advent of the automatic tumble dryer, the drying process has become significantly more rapid. However, such a benefit comes at a cost of increased power consumption which presents an additional cost to the consumer and is environmentally less expedient.

It is therefore desirable to reduce the drying time of laundered fabrics when both line dried and machine tumble dried.

EP-A1-224839 and EP-A1-200325 both disclose that silicone may be dispersed in rinse water combined with other laundry additives such as fabric conditioning compositions to reduce the drying time of fabrics. The silicone is in addition to any fabric conditioning composition which may be added.

WO 01/73187 discloses a method for reducing the drying time of fabric comprising treating the fabric with a treatment composition comprising formaldehyde, a catalyst for crosslinking the formaldehyde with natural fibres in the fabric, and silicone elastomer or a precursor thereof, and heating the treated fabric to effect crosslinking of the formaldehyde. This is a complex operation which requires a heating stage to effect a chemical reaction within the components.

U.S. Pat. No. 4,337,166 discloses a fast-dry shampoo composition which contains cyclic methyl siloxanes.

WO-A1-01/60961 discloses laundry compositions containing superwetting silicones for enhanced penetration of active ingredients and anti-wrinkles benefits

In addition to providing the abovementioned benefits, it is highly desirable that the composition remains stable upon storage.

Instability can manifest itself as a thickening of the product upon storage, even to the point that the product is no longer pourable.

The problem of thickening upon storage is particularly apparent in concentrated fabric softening compositions comprising an ester-linked quaternary ammonium fabric softening material having one or more fully saturated alkyl chains.

### OBJECTS OF THE INVENTION

The present invention seeks to address one or more of the aforementioned problems and to provide one or more of the aforementioned benefits.

### STATEMENT OF INVENTION

Thus, according to the present invention there is provided the use of a nonionic surfactant in a laundry treatment composition to reduce the drying time of laundered fabrics.

### DETAILED DESCRIPTION OF THE INVENTION

In the context of the present invention, the term “comprising” denotes that the feature(s) to which it refers is/are not exhaustive and further features may be present.

Nonionic Surfactant

Suitable nonionic surfactants include organic surfactants, silicone-containing surfactants and fluorine-containing surfactants.

Suitable nonionic surfactants include, but are not limited to, addition products of ethylene oxide and/or propylene oxide with fatty alcohols, fatty acids and fatty amines.

Any of the alkoxylated materials of the particular type described hereinafter are suitable for use either alone or in combination as the nonionic surfactant.

Suitable surfactants are substantially water soluble surfactants of the general formula:
R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the alkoxylated nonionic surfactant, Y is typically:
—O—, —C(O)O—, —C(O)N(R)— or —C(O)N(R)R—

in which R has the meaning given above or can be hydrogen;

and Z is preferably from 3 to 40, more preferably from 5 to 30, most preferably from 7 to 25, e.g. 10 to 22.

The level of alkoxylation, Z, denotes the average number of alkoxy groups per molecule.

As will be apparent to the person skilled in the art, in a sample where many molecules are present, the level of alkoxylation will not be the same for every molecule and so Z is unlikely to be an integer.

Preferably the nonionic surfactant has an HLB of from about 6 to about 20, more preferably from 7 to 18, most preferably from 8 to 15.

Examples of nonionic surfactants follow. In the examples, the integer defines the number of ethoxy (EO) groups in the molecule.

A. Straight-Chain, Primary Alcohol Alkoxylates

The tri-, penta-, septa-, deca-, undeca-, dodeca-, trideca, tetradeca-, and pentadecaethoxylates of n-tridecanol, n-hexadecanol, and n-octadecanol having an HLB within the range recited herein are useful in the context of this invention. Exemplary ethoxylated primary alcohols useful herein are C₁₃ EO(3) and C₁₃C₁₈ EO(7). The ethoxylates of mixed natural or synthetic alcohols in the “tallow” chain length range are also useful herein. Specific examples of such materials include tallow alcohol-EO(11), tallow alcohol-EO(18), and tallow alcohol-EO(25), coco alcohol-EO(10), coco alcohol-EO(15), coco alcohol-EO(20) and coco alcohol-EO(25).

B. Straight-Chain, Secondary Alcohol Alkoxylates

The tri-, penta-, septa-, deca-, undeca-, dodeca-, trideca, tetradeca-, pentadeca-, octadeca-, and nonadeca-ethoxylates of 3-hexadecanol, 2-octadecanol, 4-eicosanol, and 5-eicosanol having an HLB within the range recited herein are useful in the context of this invention. Exemplary ethoxylated secondary alcohols useful herein are: C₁₆ EO(11); C₂₀ EO(11); and C₁₆ EO(14).

C. Alkyl Phenol Alkoxylates

As in the case of the alcohol alkoxylates, the tri- to octadeca-ethoxylates of alkylated phenols, particularly monohydric alkylphenols, having an HLB within the range recited herein are useful. The tri- to octadeca-ethoxylates of p-tri-decylphenol, m-pentadecylphenol, and the like, are useful herein. Exemplary ethoxylated alkylphenols useful herein are: p-tridecylphenol EO(11) and p-pentadecylphenol EO(18).

As used herein and as generally recognised in the art, a phenylene group in the nonionic formula is the equivalent of an alkylene group containing from 2 to 4 carbon atoms. For present purposes, nonionics containing a phenylene group are considered to contain an equivalent number of carbon atoms calculated as the sum of the carbon atoms in the alkyl group plus about 3.3 carbon atoms for each phenylene group.

D. Olefinic Alkoxylates

The alkenyl alcohols, both primary and secondary, and alkenyl phenols corresponding to those disclosed immediately hereinabove can be ethoxylated to an HLB within the range recited herein and used in the instant compositions.

E. Branched Chain Alkoxylates

Branched chain primary and secondary alcohols which are available from the well-known “OXO” process can be ethoxylated and employed herein.

F. Polyol Based Surfactants

Suitable polyol based surfactants include sucrose esters such sucrose monooleates, alkyl polyglucosides such as stearyl monoglucosides and stearyl triglucoside and alkyl polyglycerols.

Suitable silicone and fluorine containing surfactants are described in Nonionic surfactants, Surfactant Science Series, Volume 1, Ed. M. J. Schick, Edward Arnold Publishers, London, pages 350-352, 418 and The Aqueous Phase Behaviour of Surfactants, R. G. Laughlin, Academic Press, London, 1994, pages 355-361 and the references contained therein.

The above nonionic surfactants are useful in the present compositions alone or in combination, and the term “nonionic surfactant” encompasses mixed nonionic surface active agents.

The nonionic surfactant is present in an amount from 0.01 to 10%, more preferably 0.1 to 5%, most preferably 0.35 to 3.5%, e.g. 0.5 to 2% by weight, based on the total weight of the composition.

Formulations

The compositions of the present invention may take any suitable form, such as a liquid, solid or gel.

The compositions preferably also comprise one or more textile compatible wash components. The nature of the wash components will be dictated to a large extent by the stage at which the composition of the invention is to be used in the laundering process, the compositions being capable of being used, in principle, at any stage of the process. For example, where the compositions are for use as main wash detergent compositions, the one or more wash components include a detergent active compound. Where the compositions are for use in the rinsing step of a laundering process, the one or more wash components may include a fabric softening and/or conditioning compound.

The compositions of the invention preferably comprise a perfume, such as of the type which is conventionally used in fabric care compositions. It is well known that perfume is provided as a mixture of various components. Suitable components for use in the perfume include those described in “Perfume and Flavor Chemicals (Aroma Chemicals) by Steffen Arctander, published by the author 1969 Montclait, N.J. (US), reprinted 1^{st} Apr. 1982 library of Congress Catalog Number 75-91398.

The perfume is preferably present in an amount from 0.01 to 10% by weight, more preferably 0.05 to 5% by weight, most preferably 0.5 to 4.0% by weight, based on the total weight of the composition.

In the context of the present invention the wash component can also provide benefits in addition to those provided by the nonionic surfactant e.g. softening, cleaning etc.

The wash component may be an aqueous liquid, in which case the nonionic surfactant is dispersed or dissolved in the liquid as appropriate.

Suitable liquid carriers are at least partly water due to its low cost relative availability, safety, and environmental compatibility. The level of water in the liquid carrier is more than about 50%, preferably more than about 80%, more preferably more than about 85%, by weight of the carrier. The level of liquid carrier is greater than about 50%, preferably greater than about 65%, more preferably greater than about 70% by weight of the composition. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and polyhydric (polyols) alcohols are also suitable carriers for use in the compositions.

Alternatively, the wash component may be a solid component e.g. granular. In this case, the nonionic surfactant may simply be admixed with the wash component. One way to achieve this may be to spray dry a slurry comprising water and the nonionic surfactant. In an alternative embodiment, the wash component and nonionic surfactant are formed together into a solid granular product, in accordance with conventional techniques.

If the composition is to be used before the laundry process, however, it may be in the form of a spray or foaming product.

The fabrics which may be treated with compositions according to the present invention include those which comprise cellulosic fibres, preferably from 1% to 100% cellulosic fibres (more preferably 5% to 100% cellulosic fibres, most preferably 40% to 100%). The fabric may be in the form of a garment, in which case the method of the invention may represent a method of laundering a garment. When the fabric contains less than 100% cellulosic fibres, the balance comprises other fibres or blends of fibres suitable for use in garments such as polyester, for example. Preferably, the cellulosic fibres are of cotton or regenerated cellulose such as viscose.

The laundering processes of the present invention include the large scale and small scale (e.g. domestic) cleaning of fabrics. Preferably, the processes are domestic.

Main wash Detergent Compositions

Detergent Active Compounds

If the composition is in the form of a detergent composition, the wash component may include a detergent chosen from soap and non-soap anionic, cationic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred detergent wash components that can be used are soaps and synthetic non-soap anionic compounds.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Cationic surfactants that may be used include quaternary ammonium salts of the general formula R₁R₂R₃R₄N⁺X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt %, more preferably from 0.5 to 55 wt %, most preferably from 5 to 50 wt %.

Preferably, the quantity of anionic surfactant (when present) is in the range of from 1 to 50% by weight, more preferably 3 to 35% by weight, most preferably 5 to 30% by weight of the total composition.

Amphoteric surfactants may also be used, for example amine oxides or betaines.

The compositions may suitably contain from 10 to 70%, preferably from 15 to 70% by weight, of detergency builder. Preferably, the quantity of builder is in the range of from 15 to 50% by weight.

The detergent composition may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:
0.8-1.5 M₂O.Al₂O₃. 0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

Rinse Conditioners

Cationic Softening Material

If the composition is in the form of a rinse conditioner, it may comprise a cationic softening material.

Preferred cationic softening materials for use herein are quaternary ammonium fabric softening materials.

The quaternary ammonium fabric softening material compound has two C₁₂₋₂₈ alkyl or alkenyl groups connected to the nitrogen head group, preferably via at least one ester link. It is more preferred if the quaternary ammonium material has two ester links present.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear.

The first group of cationic fabric softening compounds for use in the invention is represented by formula (I):

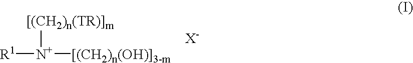

wherein each R is independently selected from a C₅₋₃₅ alkyl or alkenyl group, R¹ represents a C₁₋₄ alkyl, C₂₋₄ alkenyl or a C₁₋₄ hydroxyalkyl group,

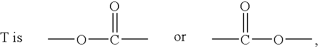

n is 0 or a number selected from 1 to 4, m is 1, 2 or 3 and denotes the number of moieties to which it relates that pend directly from the N atom, and X⁻ is an anionic group, such as halides or alkyl sulphates, e.g. chloride, methyl sulphate or ethyl sulphate.

Especially preferred materials within this formula are di-alkenyl esters of triethanol ammonium methyl sulphate. Commercial examples include Tetranyl AHT-1 (di-hardened oleic ester of triethanol ammonium methyl sulphate 80% active), AT-1 (di-oleic ester of triethanol ammonium methyl sulphate 90% active), L5/90 (palm ester of triethanol ammonium methyl sulphate 90% active), all ex Kao and Rewoquat WE15 (C₁₀-C₂₀ and C₁₆-C₁₈ unsaturated fatty acid reaction products with triethanolamine dimethyl sulphate quaternised 90% active), ex Witco Corporation.

The second group of cationic fabric softening compounds for use in the invention is represented by formula (II):

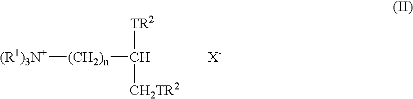

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined above.

Preferred materials of this class such as 1,2 bis(tallowoyloxyl-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A third group of cationic fabric softening compounds for use in the invention is represented by formula (III):

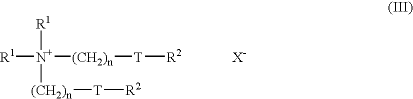

wherein each R¹ group is independently selected from C₁₋₄ alkyl, or C₂₋₄ alkenyl groups; and wherein each R group is independently selected from C₈₋₂₈ alkyl or alkenyl groups; n is 0 or an integer from 1 to 5 and T and X⁻ are as defined above.

A fourth group of cationic fabric softening compounds for use in the invention is represented by formula (IV):

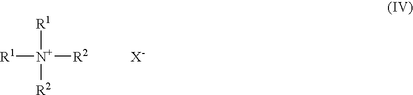

wherein each R¹ group is independently selected from C₁₋₄ alkyl, or C₂₋₄ alkenyl groups; and wherein each R² group is independently selected from C₈₋₂₈ alkyl or alkenyl groups; and X⁻ is as defined above.

Iodine Value of the Parent Fatty Acyl Group or Acid

The iodine value of the parent fatty acyl compound or acid from which the cationic softening material is formed is from 0 to 140, preferably from 0 to 100, more preferably from 0 to 60.

It is especially preferred that the iodine value of the parent compound is from 0 to 20, e.g. 0 to 4. Where the iodine value is 4 or less, the softening material provides excellent softening results and has improved resistance to oxidation and associated odour problems upon storage.

When unsaturated hydrocarbyl chains are present, it is preferred that the cis:trans weight ratio of the material is 50:50 or more, more preferably 60:40 or more, most preferably 70:30 or more, e.g. 85:15 or more.

The iodine value of the parent fatty acid or acyl compound is measured according to the method set out in respect of parent fatty acids in WO-A1-01/46513.

The softening material is preferably present in an amount of from 1 to 60% by weight of the total composition, more preferably from 2 to 40%, most preferably from 3 to 30% by weight.

Silicone

It may be desirable for a silicone to be present in the composition.

Typical silicones for use in the composition are siloxanes which have the general formula RₐSiO_{(4-a)/2} wherein each R is the same or different and is selected from hydrocarbon and hydroxyl groups, “a” being from 0 to 3. In the bulk material, “a” typically has an average value of from 1.85-2.2.

The silicone can have a linear or cyclic structure.

Preferably, the silicone is a polydi-C₁₋₆alkyl siloxane.

Particularly preferred is polydimethyl siloxane. The siloxane is preferably end-terminated, if linear, either by a tri-C₁₋₆ alkylsilyl group (e.g. trimethylsilyl) or a hydroxy-di-C₁₋₆ alkylsilyl group (e.g. hydroxy-dimethylsilyl) groups, or by both.

More preferably the silicone is a cyclic polydimethyl siloxane.

Suitable commercially available silicones include DC245 (polydimethylcyclopentasiloxane also known as D5), DC246 (polydimethylcyclohexasiloxane also known as D6), DC1184 (a pre-emulsified polydimethylpentasiloxane also known as L5) and DC347 (a pre-emulsified 100 cSt PDMS fluid) all ex Dow Corning.

Silicone Form

If present, the silicone may be received and incorporated into the composition either directly as an oil or pre-emulsified.

Pre-emulsification is typically required when the silicone is of a more viscous nature.

Suitable emulsifiers include cationic emulsifiers, nonionic emulsifiers or mixtures thereof.

If emulsified it is preferred that the silicone droplets are incorporated in the form of a macro-emulsion, that is to say the droplets have a median size in the wavelength range corresponding to the visible spectrum, or even larger. Preferably, the emulsion is an oil-in-water emulsion. The term “median size” refers to the number average. The visible spectrum is 0.39 μm to 0.77 μm. In the emulsion, the silicone droplets are then preferably from 0.39 μm to 25 μm. The droplet size may be determined based on measurements of median DV05 using a Malvern X Mastersizer.

Emulsification can be effected using one or more cationic surfactants, preferably having a non-halogen counter-ion.

The cationic emulsifiers are believed to enhance deposition of the silicone during use of the fabric softening composition. Preferred counter-ions include methosulphate, ethosulphate, tosylate, phosphate and nitrate. If a halogen counter-ion is used, it is preferably chloride.

If an emulsifier is present, it is desirable that the total of amount of emulsifying surfactant(s) is from 0.5% to 20%, preferably from 2% to 12%, more preferably from 3% to 10% by weight of the emulsion.

The total amount of silicone in the emulsion will generally be up to 70% by weight of the emulsion.

Preferably, the weight ratio of silicone to total emulsifying surfactant(s) is from 2.3:1 to 120:1, more preferably 3:1 to 120:1, for example from 3:1 to 30:1. Typical cationic surfactants are alkyl tri-methylammonium methosulphates and derivatives in which at least two of the methyl groups on the nitrogen atom are replaced by (poly)alkoxylated groups.

Silicone Viscosity

The reference to the viscosity of the silicone denotes the viscosity of the silicone itself when provided as an oil for incorporation into the fabric conditioning composition.

The silicone preferably has a viscosity (as measured on a Brookfield RV4 viscometer at 25° C. using spindle No. 4 at 100 rpm) of from 1 cSt to 500,000 cSt. It is more preferred than the viscosity of the silicone is less than 10,000 centi-Stokes (cSt), preferably from 1 cSt to 5,000 cSt, more preferably from 2 cSt to 1,000 cSt and most preferably 2 cSt to 100 cSt.

It is also possible to provide the silicone as an emulsion which is then incorporated into the composition. For such silicones, the viscosity before emulsification (as measured on a Brookfield RV4 viscometer at 25° C. using spindle No. 4 at 100 rpm) is preferably from 1 cSt to 1,000,000 cSt, preferably from 30,000 cSt to 750,000 cSt, more preferably from 40,000 cSt to 400,000 cSt, most preferably 45,000 cSt to 250,000 cSt, e.g. 45,000 cSt to 200,000 cSt.

The silicone active ingredient is preferably present at a level of from 0.5 to 20%, more preferably from 1 to 12%, most preferably from 2 to 8% by weight, based on the total weight of the composition.

Fatty Alcohol

Optionally and advantageously, one or more un-alkoxylated fatty alcohols are present in the composition.

Preferred alcohols have a hydrocarbyl chain length of from 10 to 22 carbon atoms, more preferably 11 to 20 carbon atoms, most preferably 15 to 19 carbon atoms.

The fatty alcohol may be saturated or unsaturated, though saturated fatty alcohols are preferred as these have been found to deliver greater benefits in terms of stability, especially low temperature stability.

Suitable commercially available fatty alcohols include tallow alcohol (available as Hydrenol S3, ex Sidobre Sinnova, and Laurex CS, ex Clariant).

The fatty alcohol content in the compositions is from 0 to 10% by weight, more preferably from 0.005 to 5% by weight, most preferably from 0.01 to 3% by weight, based on the total weight of the composition.

It is particularly preferred that a fatty alcohol is present if the composition is concentrated, that is if more than 8% by weight of the cationic softening agent is present in the composition.

Other Co-Active Softeners

Co-active softeners for the cationic surfactant may also be incorporated in an amount from 0.01 to 20% by weight, more preferably 0.05 to 10%, based on the total weight of the composition. Preferred co-active softeners include fatty esters, and fatty N-oxides.

Preferred fatty esters include fatty monoesters, such as glycerol monostearate (hereinafter referred to as “GMS”). If GMS is present, then it is preferred that the level of GMS in the composition is from 0.01 to 10% by weight, based on the total weight of the composition.

The co-active softener may also comprise an oily sugar derivative. Suitable oily sugar derivatives, their methods of manufacture and their preferred amounts are described in WO-A1-01/46361 on page 5 line 16 to page 11 line 20, the disclosure of which is incorporated herein.

Polymeric Viscosity Control Agents

It is useful, though not essential, if the compositions comprise one or more polymeric viscosity control agents. Suitable polymeric viscosity control agents include nonionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Nonionic and/or cationic polymers are preferably present in an amount of 0.01 to 5 wt %, more preferably 0.02 to 4 wt %, based on the total weight of the composition.

Further Optional Ingredients

Other optional nonionic softeners, bactericides, soil-releases agents may also be incorporated in the compositions of the invention.

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, pearlescers, anti-shrinking agents, anti-wrinkle agents, anti-spotting agents, antioxidants, sunscreens, anti-corrosion agents, drape imparting agents, preservatives, anti-static agents, ironing aids and dyes.

### EXAMPLES

The invention will now be illustrated by the following non-limiting examples. Further modifications will be apparent to the person skilled in the art.

All values are % by weight of the active ingredient unless stated otherwise.

### Example 1

### Evaluation of Water Retention Using Main-Wash Compositions Added into the Main-Wash Cycle

The following main Wash Test Samples were prepared:

TABLE 1

| | Nonionic | Anionic | Nonionic | Anionic |
|---|---|---|---|---|
| Main Wash | Surfactant | Surfactant | Surfactant | Surfactant |
| Test Sample | (1) | (2) | (3) | (4) |
| Water | — | — | — | — |
| 1 | — | 100.0 | — | — |
| 2 | 20.0 | 80.0 | — | — |
| 3 | 50.0 | 50.0 | — | — |
| 4 | 80.0 | 20.0 | — | — |
| 5 | 100.0 | — | — | — |
| 6 | — | — | 82.5 | 17.5 |

(1) Lutensol 7EO, ex BASF
(2) sodium LAS
(3) Neodol 1-5 ex. Shell
(4) Praepagen ex. Clariant (aqueous solution of lauryl dimethyl hydroxy ethyl ammonium chloride

1.5 Kg loads comprising desized Terry Towelling (40×60 cm) and 9 Terry monitors (20×20 cm) were weighed and placed in a Miele W754S washing machine. The loads were then washed on a 40° C. cotton cycle using 37.5 g of the main wash test sample.

After the rinse cycle had completed and prior to the final spin cycle, the loads were wrung out by hand and separated to form a load comprising only the monitors and a separate load comprising the rest of the Terry Towelling. The monitors were then stacked in groups of three flat against the sides of the washing machine drum and secured with duct tape to hold them in position until the spin started. A final 1200 rpm spin was then started and allowed to complete.

Separately, the Terry Towelling load was spun at 1200 rpm.

As soon as the wash was completed the fabric monitors were re-weighed.

Water retention at this stage was calculated using the following equation:

$$\begin{matrix}\% water retention \\ of fabric\end{matrix} = 100 \times ( \frac{( wet weight - dry weight )}{dry weight} )$$

For each sample, the test was replicated and the result averaged.

The results are given in the table below.

TABLE 2

| Main Wash | Water retention | Water retention of |
|---|---|---|
| Test Sample | of monitor load | Terry Towelling load |
| Water | 73.0 | 55.5 |
| 1 | 62.3 | 56.2 |
| 2 | 56.6 | 53.8 |
| 3 | 55.4 | 51.3 |
| 4 | 51.6 | 49.7 |
| 5 | 50.7 | 46.2 |
| 6 | 51.0 | 49.0 |

### Example 2

### Evaluation of Water Retention Using Rinse Added Compositions Added into Rinse Cycle

3 stacks of 3 Terry Monitors (20×20 cm) were weighed and rinsed in a beaker containing 660ml of an aqueous rinse liquor. The rinse liquors are shown in tables 3 and 4 below.

The monitors were then removed from the liquor, hand wrung, placed flat against the side of a washing machine drum and secured with tape. A single spin at 1200 rpm was then carried out.

The monitors were the removed, reweighed and the level of water retention calculated in the manner described above.

TABLE 3

| | Water | |
|---|---|---|
| Rinse liquor | retention | Notes |
| Water | 65.3 | |
| 0.1M Coco 3EO | 53.9 | Marlipal 24/30 |
| 0.1M Coco 5EO | 53.5 | Genapol C050 |
| 0.1M Coco 7EO | 55.8 | Marlipal 24/70 |
| 0.1M Coco 10EO | 58.8 | Genapol C100 |

TABLE 4

| | Water | |
|---|---|---|
| Rinse Liquor | retention | Notes |
| Water | 70 | |
| 0.1M Isotridecanol 3EO | 54.8 | Lutensol TO 3 |
| 0.1M Isotridecanol 5EO | 54.2 | Lutensol TO 5 |
| 0.1M Isotridecanol 7EO | 54.5 | Lutensol TO 7 |
| 0.1M Isotridecanol 10EO | 56.4 | Lutensol TO 10 |
| 0.1M Isotridecanol 15EO | 56.9 | Lutensol TO 15 |
| 0.1M Isotridecanol 20EO | 59.1 | Lutensol TO 20 |

Lutensol materials ex BASF
Genapol materials ex Clariant
Marlipal materials ex Sasol

### Example 3

### Evaluation Dynamic Surface Tension of Silicon-Containing Non-Ionic Surfactants

The preparation and evaluation of samples described in example 2 was also carried out on the samples shown in table 5 below.

Surface tension measurements were carried out on a Tensiometer Tracker (I.T. Concept). The method used a rising pendant air droplet injected from a needle into a test solution, with software calculation based on the shape of the air droplet using video technique.

TABLE 5

| | Water | Dynamic surface |
|---|---|---|
| Sample | retention | tension (mN/m) |
| Water | 74.8 | 70.7 |
| DC Q2 5211* | 49.8 | 20.2 |
| DC Q2 5212* | 52.0 | 21.9 |
| Silwet L-77** | 51.2 | 20.3 |

Materials based on methyl (propylhydroxide, ethoxylated) bis(trimethylsiloxy) silane (“silicone superwetters”)
*ex Dow Corning
**ex Osi Specialities

In the following tables, 5% dispersions of DC5211, DC5212 and Silwet L-77 in a commercially available fabric conditioner (Concentrated Comfort) were prepared and 1.54 g of the dispersions were dosed into 660 ml water to form a rinse liquor. The results for these samples were compared to a rinse liquor comprising a 1.54 g dispersion of Concentrated Comfort in 600 ml water.

TABLE 6

| | Water | Dynamic surface tension |
|---|---|---|
| Sample | retention | (mN/m) |
| Concentrated | 56.1 | 66.5 |
| Comfort* | | |
| DC5211 ex Dow | 53.1 | 36.6 |
| Corning | | |

*purchased in UK June 2001

TABLE 7

| | Water | Dynamic surface tension |
|---|---|---|
| Sample | retention | (mN/m) |
| Concentrated | 45.3 | 70.1 |
| Comfort** | | |
| DC5212 ex Dow | 43.6 | 63.4 |
| Corning | | |
| Silwet L-77 ex | 43.5 | 62.1 |
| OSi Specialities | | |

**purchased in UK, March 2002

1. Use of a nonionic surfactant in a laundry treatment composition to reduce the drying time of laundered fabrics.

2. Use according to claim 1 in which the nonionic surfactant comprises addition products of ethylene oxide and/or propylene oxide with fatty alcohols, fatty acids and/or fatty amines.

3. Use according to claim 1 in which the nonionic surfactant comprises silicone-containing surfactants.

4. Use according to claim 1 in which the nonionic surfactant comprises fluorine-containing surfactants.

5. Use according to claim 1 in which the laundry treatment composition is a detergent composition.

6. Use according to claim 1 in which nonionic surfactant is an ethoxylated alcohol.

7. Use according to claim 6 in which the ethoxylated alcohol has an average degree of ethoxylation of from 3 to 40, more preferably from 5 to 30, most preferably from 7 to 25.

8. Use according to claim 1 in which the nonionic surfactant is present in an amount of from 0.01 to 10%, more preferably 0.1 to 5%, most preferably 0.35 to 3.5%, e.g. 0.5 to 2% by weight, based on the total weight of the composition.
